(19) United States
(12) Patent Application Publication
(10) Pub. No.: US 2020/0255083 A1
(43) Pub. Date: Aug. 13, 2020

(54) BRAKE PIPING STRUCTURE FOR SADDLED VEHICLES

(71) Applicant: HONDA MOTOR CO., LTD., Tokyo (JP)

(72) Inventors: Yosuke MATSUOKA, Wako-shi (JP); Manabu ICHIKAWA, Wako-shi (JP)

(73) Assignee: HONDA MOTOR CO., LTD., Tokyo (JP)

(21) Appl. No.: 16/639,208

(22) PCT Filed: May 31, 2018
(86) PCT No.: PCT/JP2018/021030

§ 371 Date: Feb. 14, 2020

(30) Foreign Application Priority Data
Sep. 28, 2017 (JP) 2017-188405

(51) Int. Cl. B62K 19/38; B62L 3/08

(52) U.S. Cl. CPC B62K 19/38; B60T 8/3685; B62L 3/08

(57) ABSTRACT

To provide a brake piping structure for saddled vehicle which can reduce the number of restraining members used for brake piping and allow brake piping to avoid interfering with other parts. The brake piping structure for saddled vehicles includes a pair of left and right rear frames connected to a rear portion of a vehicle body frame of a saddled vehicle and supporting a seat, a swing arm swingably supported, via a pivot, by the vehicle body frame, and brake piping which conveys hydraulic pressure generated by an ABS modulator to a rear brake caliper for a rear wheel. The ABS modulator is disposed between the pair of left and right rear frames. The brake piping extends from the ABS modulator forward and downward of the vehicle body along the rear frame and is, by being curved rearward of the vehicle body in front of the pivot and then by being routed under the swing arm, connected to the rear brake caliper.

### TECHNICAL FIELD

The present invention relates to a brake piping structure for saddled vehicles, and more particularly to the brake piping structure for the saddled vehicles arranged between an ABS modulator and a brake caliper which generates braking force against a wheel.

### BACKGROUND ART

A configuration of the brake piping structure for the saddled vehicles has been known in which the ABS modulator to generate brake hydraulic pressure and the brake caliper to generate braking force against a wheel by using supplied hydraulic pressure are interconnected via brake piping.

In patent document 1, a configuration in a motorcycle having rear frames extending rearward of a vehicle body from behind a main frame and supporting a seat, etc. and a swing arm rotatably supporting the rear wheel is disclosed in which brake piping extending from the ABS modulator disposed under the seat and connected to a rear brake caliper is routed along upper surfaces of the rear frame and the swing arm.

### CITATION LIST

### Patent Literature

Patent Document 1: JP 2017-30394 A

### SUMMARY OF INVENTION

### Technical Problem

However, the configuration disclosed in the patent document 1 poses problem that plural restraining members are required to route brake piping along the rear frame and the swing arm, and the number of parts and assembly man-hours increase while making appearance property liable to deteriorate. Meanwhile, concerning a structure in which brake piping is routed to span from the rear frame to the swing arm side, a structure in which swinging of the swing arm neither generates a burden on the brake piping nor causes the brake piping to interfere with other parts has been desired.

An object of the present invention is to provide the brake piping structure for the saddled vehicles which can solve the problems of the above prior art and can reduce the number of restraining members used for brake piping and allows brake piping to avoid interfering with other parts.

### Solution to Problem

To achieve the afore-mentioned object, the present invention has a first feature in that a brake piping structure for saddled vehicles comprises a pair of left and right rear frames (29) connected to a rear portion of a vehicle body frame (3) of the saddled vehicle (1) and supporting a seat (31), a swing arm (23) swingably supported, via a pivot (18), by the vehicle body frame (3), and brake piping (111) which conveys hydraulic pressure generated by an ABS modulator (27) to a rear brake caliper (112) for a rear wheel (WR), wherein the ABS modulator (27) is disposed between the pair of left and right rear frames (29) and wherein the brake piping (111) extends from the ABS modulator (27) forward and downward of the vehicle body along the rear frame (29) and is, by being curved rearward of the vehicle body in front of the pivot (18) and then by being routed under the swing arm (23), connected to the rear brake caliper (112).

To achieve the afore-mentioned object, the present invention has a second feature in that a connection terminal (110) for the brake piping (111) is provided at the ABS modulator (27), and the connection terminal (110) is oriented forward and downward of the vehicle body along the rear frame (29).

To achieve the afore-mentioned object, the present invention has a third feature in that an arc-like guide member (116) for guiding the brake piping (111) is attached to a cylindrical portion (23a) pivotally supporting the pivot (18) at a front end portion of the swing arm (23).

To achieve the afore-mentioned object, the present invention has a fourth feature in that at least a portion, leading from the ABS modulator (27) to in front of the guide member (116), of the brake piping (111) is formed of a metal hose.

To achieve the afore-mentioned object, the present invention has a fifth feature in that the brake piping structure includes a master cylinder (114) which generates hydraulic pressure responding to operation of a brake pedal (102), wherein the master cylinder (114) is fixed to a pivot plate (19) pivotally supporting the pivot (18) and wherein second brake piping (115) which conveys hydraulic pressure generated at the master cylinder (114) to the ABS modulator (27) is routed on an inner side in the vehicle width direction of the rear frame (29).

### Effects of Invention

According to the first feature of the present invention, a brake piping structure for the saddled vehicles comprises a pair of left and right rear frames (29) connected to a rear portion of the vehicle body frame (3) of the saddled vehicle (1) and supporting a seat (31), a swing arm (23) swingably supported, via a pivot (18), by the vehicle body frame (3), and brake piping (111) which conveys hydraulic pressure generated by an ABS modulator (27) to a rear brake caliper (112) for a rear wheel (WR), wherein the ABS modulator (27) is disposed between the pair of left and right rear frames (29) and wherein the brake piping (111) extends from the ABS modulator (27) forward and downward of the vehicle body along the rear frame (29) and is, by being curved rearward of the vehicle body in front of the pivot (18) and then by being routed under the swing arm (23), connected to the rear brake caliper (112). Therefore, with the ABS modulator disposed between the rear frames, they are disposed close to each other, making it easy to extend the brake piping along the inner side of the rear frame. This makes it possible to hide the brake piping with the rear frame, so that appearance property can be improved. Furthermore, curving the brake piping rearward in front of a pivot makes it unnecessary to use plural restraining members to route the brake piping along the rear frame. This reduces the number of parts and production man-hours and, at the same time, with curving of the brake piping held small, effects of swinging of the swing arm on the brake piping can be suppressed and the brake piping can be prevented from interfering with other parts such as a rear cushion.

According to the second feature of the present invention, a connection terminal (110) for the brake piping (111) is provided at the ABS modulator (27), and the connection terminal (110) is oriented forward and downward of the vehicle body along the rear frame (29). Therefore, it is easy to route the brake piping along the rear frame without using restraining members.

According to the third feature of the present invention, an arc-like guide member (116) for guiding the brake piping (111) is attached to a cylindrical portion (23a) pivotally supporting the pivot (18) at a front end portion of the swing arm (23). Therefore, the portion to be curved in front of the swing arm of the brake piping can be guided more stably.

According to the fourth feature of the present invention, at least a portion, leading from the ABS modulator (27) to in front of the guide member (116), of the brake piping (111) is formed of a metal hose. Therefore, with at least the portion from the ABS modulator to in front of the guide member of the brake piping formed of an inflexible hose, the brake piping can be easily routed along the inner side of the rear frame without using restraining members. Also, by applying a flexible hose, for example, made of rubber to the subsequent portion of the brake piping, a configuration free of load on the brake piping caused by swinging motion of the swing arm can be arranged.

According to the fifth feature of the present invention, the brake piping structure includes a master cylinder (114) which generates hydraulic pressure responding to operation of a brake pedal (102), wherein the master cylinder (114) is fixed to a pivot plate (19) pivotally supporting the pivot (18) and wherein second brake piping (115) which conveys hydraulic pressure generated at the master cylinder (114) to the ABS modulator (27) is routed on an inner side in the vehicle width direction of the rear frame (29). Therefore, the second brake piping connecting the master cylinder disposed near the pivot and the ABS modulator can be hidden on the inner side of the rear frame and, thereby, appearance property can be improved.

### BRIEF DESCRIPTION OF DRAWINGS

FIG. 1 is a left side view of a motorcycle to which the brake piping structure for saddled vehicles according to an embodiment of the present invention is applied.

FIG. 2 is a perspective view of the body frame as seen from a rear side.

FIG. 3 is a partial enlarged right-side view of the motorcycle.

FIG. 4 is a perspective view of the pivot as seen from the vehicle front side.

FIG. 5 is a perspective view equivalent to FIG. 4 with the swing arm and the rear wheel removed.

FIG. 6 is a perspective view of the swing arm as seen from below.

FIG. 7 is a perspective view of the configuration around the rear brake caliper of the brake piping.

### DESCRIPTION OF EMBODIMENTS

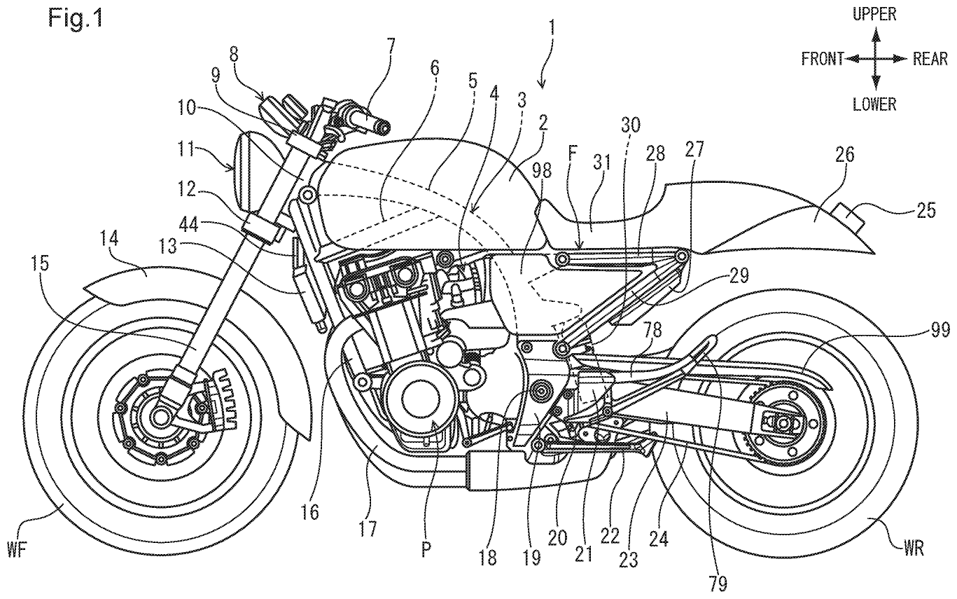

Hereinafter, a preferred embodiment of the present invention will be described in detail with reference to drawings. FIG. 1 is a left side view of a motorcycle 1 to which the brake piping structure for the saddled vehicles according to an embodiment of the present invention is applied. A body frame 3 of the motorcycle 1 as the saddled vehicle includes a main frame 5 extending, at the center in the vehicle width direction, rearward of the vehicle body from a head pipe 10 and curving downward. A pair of left and right underframes 16 extend downward of the vehicle body from a lower portion of the head pipe 10, and a pair of left and right connection pipes 6 span between intermediate positions of the underframes 16 and the main frame 5.

A lower end portion of the main frame 5 is connected with a pair of left and right pivot plates 19 provided with a pivot 18 swingably supporting a swing arm 23. The head pipe 10 rotatably supports a steering stem to a top portion of which a top bridge 9 is fixed and to a bottom portion of which a bottom bridge 12 is fixed, with the top bridge 9 and the bottom bridge 12 supporting a pair of left and right front forks 15. A steering handle 7 and a meter unit 8 are fixed to the top bridge 9. A headlight 11 is disposed in front of the head pipe 10. The front forks 15 rotatably support, at a lower end portion thereof, a front wheel WF and, at an intermediate portion thereof, support a front fender 14 covering the front wheel WF from above.

A power unit P integrally configured with a parallel 4-cylinder 4-cycle engine and a transmission is fixed below the main frame 5. The swing arm 23 swingably supported by the pivot 18 is suspended from the body frame 3 with a rear cushion 30. The rotational driving force of the power unit P is transmitted to a rear wheel WR via a drive chain 24. A chain cover 99 covering the drive chain 24 from above is attached to an upper portion of the swing arm 23. A throttle body 4 including a throttle valve and a fuel injection device is attached to the rear side of the power unit P. The combustion gas from the power unit P is guided to a muffler provided in a rear portion of the vehicle body via an exhaust pipe 17. A cooler 13 is disposed forward of the power unit P and a horn 44 is disposed on top of the cooler 13.

A fuel tank 2 is disposed on top of the main frame 5. A seat 31 integrally forming a front seat and a rear seat is disposed behind the fuel tank 2. A rear frame unit F including one pair each of upper rear frames 28 and lower rear frames 29 is attached to a rear portion of the main frame 5, and the seat 31 is disposed proximately to upper portions of the upper rear frames 28. An ABS modulator 27 for controlling brake hydraulic pressure by using an electric actuator is disposed between the left and right lower rear frames 29. A pair of side covers 98 in the vehicle width direction are disposed between the throttle body 4 and the ABS modulator 27.

Step plates 21 for supporting steps 20 on which the driver puts his/her feet and support frames 78 for supporting pillion steps 79 for a passenger are fixed to rear portions of the pivot plates 19. A side stand 22 is rotatably supported at a lower portion of the pivot plate 19. A rear fender 26 supporting a tale light 25 is disposed behind the seat 31.

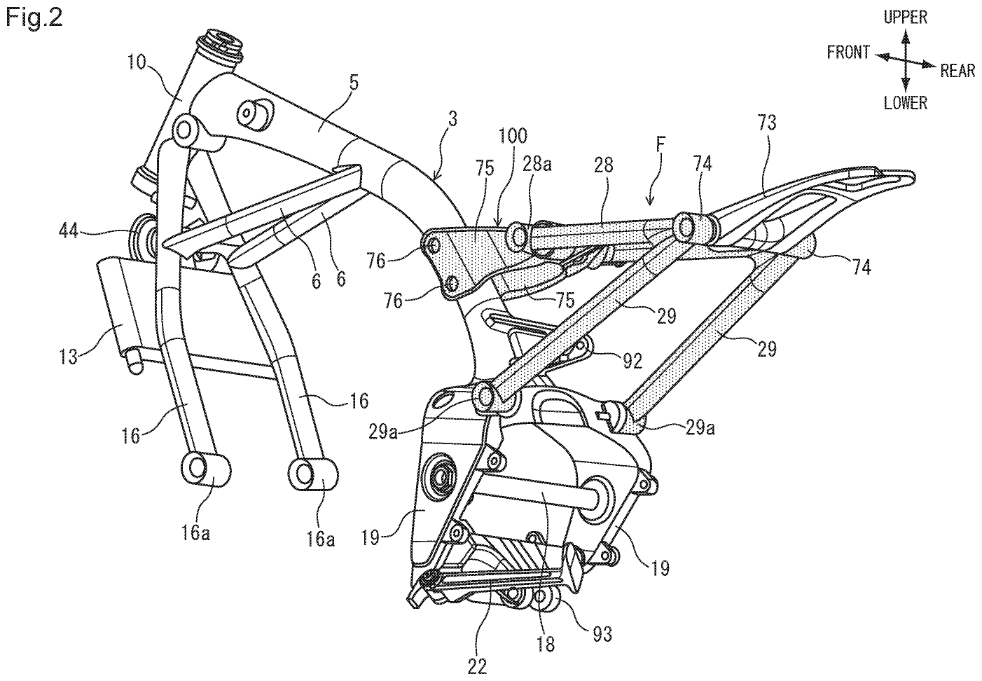

FIG. 2 is a perspective view of the body frame 3 as seen from a rear side. The main frame 5, the underframes 16 and the connecting pipes 6 are each formed of a steel pipe or the like. Cylindrical bosses 16a for mounting a front end portion of the power unit P are provided at lower end portions of the underframes 16. The pair of left and right pivot plates 19 connected to a lower rear end portion of the main frame 5 are fixed to the main frame 5 by fastening members such as bolts. A mount stay 92 pivotally supporting an upper end portion of the rear cushion 30 is provided on the back surface of the main frame 5 above the pivot plates 19. A pivot support 93 of a link mechanism connected to a lower end portion of the rear cushion 30 is provided between lower end portions of the pivot plates 19.

The rear frame unit F (represented by dotting) connected to a rearward portion of the main frame 5 is configured with upper rear frames 28 as a pair of left and right first rear frames, lower rear frames 29 as a pair of left and right second rear frames, and an intermediate frame 100 including a pair of left and right plate portions 75. Rear end portions of the upper rear frames 28 and lower rear frames 29 formed of, for example, steel pipes, are respectively coupled, for example, by welding to cylindrical bosses 74 provided toward the vehicle body rear.

On the other hand, the intermediate frame 100 is configured including a connecting portion which is provided rearward of the plate portions 75 each curvedly shaped and protruding outward in the vehicle width direction, the connecting portion connecting the left and right plate portions. An arm portion supporting a mounting portion for the fuel tank 2 is connected to a rear portion of the connecting portion. The plate portions 75 of the intermediate frame 100 are configured such that front end portions thereof are in contact with side surfaces of the main frame 5. With each of the plate portions 75 having an upper and a lower through-hole 76, the main frame 5 and the intermediate frame 100 are coupled by inserting fastening members such as bolts through the corresponding through-holes 76 of the plate portions 75. The plate portions 75 are shaped such that the dimension in the vehicle-body vertical direction increases toward the vehicle body front as viewed from a side.

A cylindrical boss 28a is provided at a front end portion of each of the upper rear frames 28, and the upper rear frames 28 and the intermediate frame 100 are coupled by fixing the cylindrical bosses 28a to the outsides in the vehicle width direction of the connecting portion 75a using fastening members such as bolts to be screwed from outside in the vehicle width direction. Cylindrical bosses 29a provided in lower end portions of the lower rear frames 29 are coupled to upper end portions of the pivot plates 19 with fastening members such as bolts. A rear stay 73 to support a rear portion of the seat 31, the rear fender 26 and the like is fixed behind the rear frame unit F with fastening members such as bolts screwed from outside the cylindrical bosses 74 in the vehicle width direction.

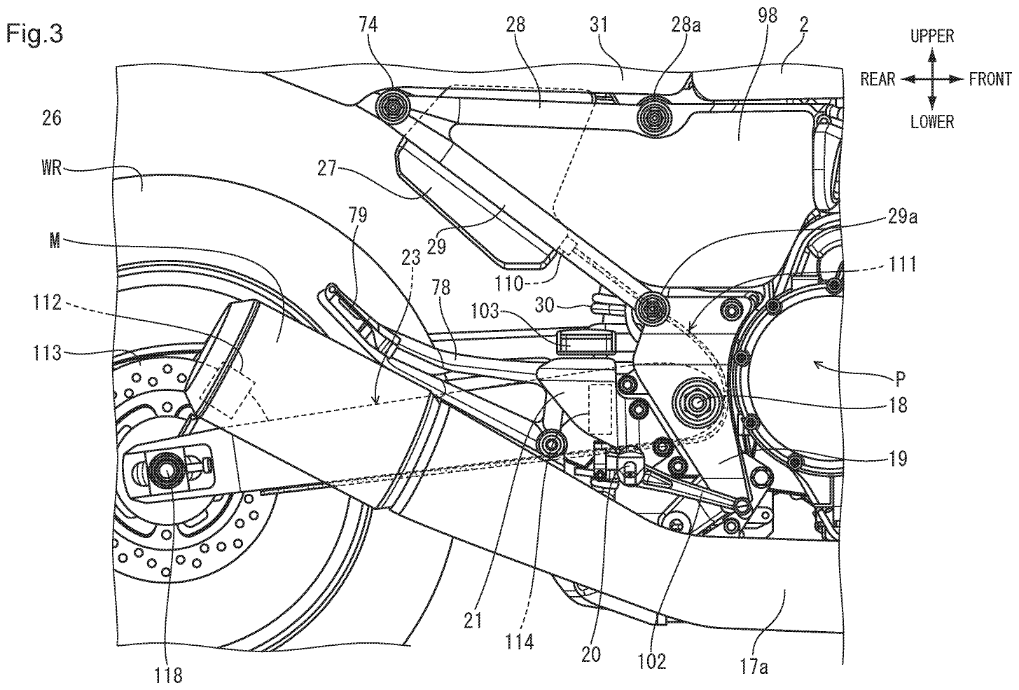

FIG. 3 is a partial enlarged right-side view of the motorcycle 1. A front/rear brake device of the motorcycle 1 is configured to generate brake hydraulic pressure using the ABS modulator 27 for providing front and rear brakes with braking force required to perform antilock brake control and front/rear interlocked brake control. For this, the hydraulic pressure generated by operating brake levers provided on the steering handle 7 and the hydraulic pressure generated by operating a brake pedal 102 disposed coaxially with the step 20 on the right side in the vehicle width direction are both once inputted to the ABS modulator, and optimum brake hydraulic pressure, inclusive of the inputted brake hydraulic pressure, corresponding to the vehicle speed and slip ratio detected by a wheel speed sensor is supplied from the ABS modulator 27 to the front and rear brake calipers.

The brake piping structure for the saddled vehicles according to the present invention relates to the piping structure of brake piping 111 for supplying brake hydraulic pressure generated at the ABS modulator 27 to the rear brake caliper 112. The ABS modulator 27 is disposed between the pairs of left and right upper rear frames 28 and lower rear frames 29 to be near the cylindrical bosses 74 in the vehicle body rear side portion. The rear brake caliper 112 that provides a brake disc 113 rotating synchronously with the rear wheel WR with braking force is disposed forward of a rear wheel axle 118 and upward of the swing arm 23.

The step plate 21 that supports the brake pedal 102 and the step 20 is disposed behind the pivot plate 19. A reservoir tank 103 of a master cylinder 114 which generates hydraulic pressure responding to operation of the brake pedal 102 is disposed above the step plate 21, and the support frame 78 that supports the pillion step 79 is disposed behind the step plate 21. A heat guard 17a which covers the exhaust pipe 17 is disposed below the support frame 78, and a muffler M communicating with the exhaust pipe 17 is disposed rearward of the heat guard 17a in the vehicle body direction.

The brake piping 111 is connected to a metallic connection terminal 110 protruding from the right side in the vehicle width direction of the ABC modulator 27 forward and downward of the vehicle body to be then guided forward and downward of the vehicle body along the inner side surface of the lower rear frame 29 on the right side in the vehicle width direction. The brake piping 111 is curved at forward of the pivot 18 to be then guided downward and rearward to extend along the underside of the swing arm 23 toward the vehicle body rear. With the connection terminal 110 of the ABS modulator 27 formed along the direction in which the lower rear frame 29 extends, the brake piping 111 connected to the connection terminal 110 can be routed along the inner side of the lower rear frame 29 without using restraining members such as bands. In this way, without the brake piping 111 exposed, appearance property improves and the number of parts can be reduced.

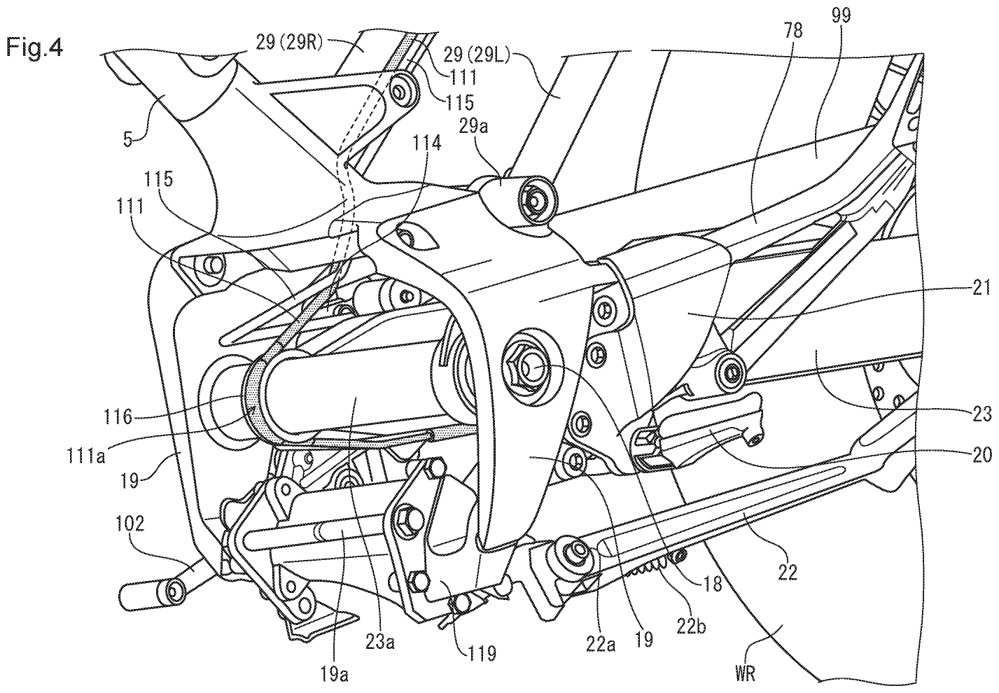

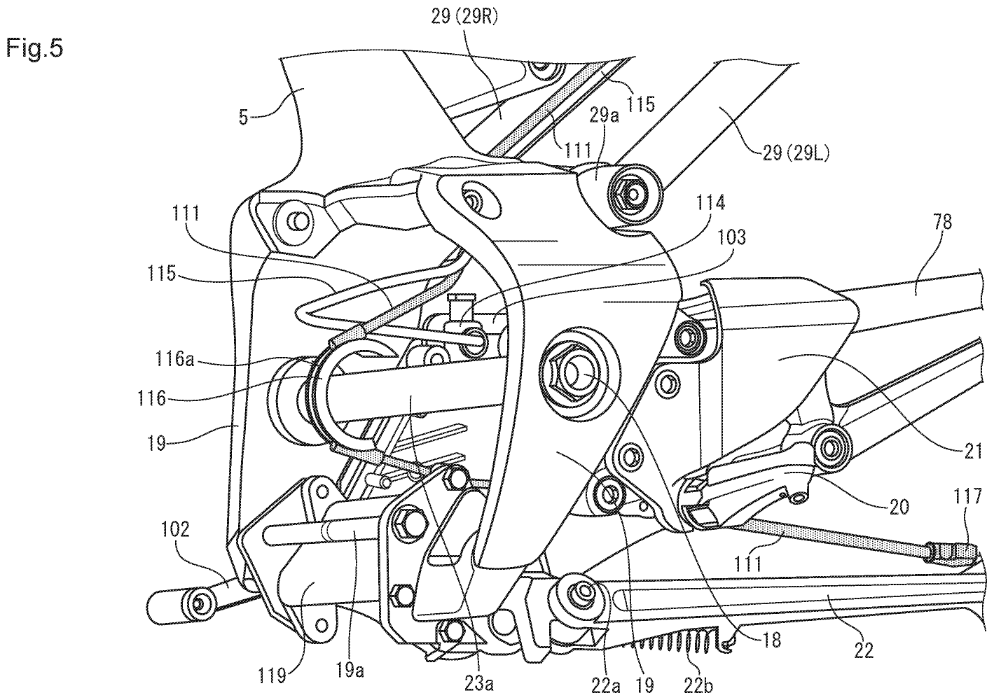

FIG. 4 is a perspective view of the pivot 18 as seen from the vehicle front side. FIG. 5 is a perspective view equivalent to FIG. 4 with the swing arm 23 and the rear wheel WR removed. A cylindrical portion 23a to pivotally support the pivot 18 is provided in a front end portion of the swing arm 23. The brake piping 111 routed along the lower rear frame 29 on the right side in the vehicle width direction is curved in front of the cylindrical portion 23a disposed on the outer peripheral side of the pivot 18 and is then routed toward the vehicle body rear. This allows curving of a curved portion 111a of the brake piping 111 to be small, so that effects of swinging of the swing arm 23 are suppressed and so that the brake piping 111 can be prevented from interfering with other parts such as the rear cushion 30.

The cylindrical portion 23a is attached with a guide member 116 approximately C-shaped as viewed from a side of the vehicle. The curved portion 111a of the brake piping 111 is accommodated in a groove 116a formed in the guide member 116 (in FIG. 5, the brake piping 111 is shown with a portion removed so as to show the shape of the groove 116a of the guide member 116). Thus, the brake piping 111 guided by the guide member 116 formed of resin or the like is not affected by swinging motion of the swing arm 23 and does not interfere with other parts such as the rear cushion 30. Even in cases without the guide member 116, with the brake piping 111 routed to pass in front of the cylindrical portion 23a, similar effects can be obtained, that is, interference with other parts such as the rear cushion 30 does not occur and the brake piping 111 is not easily affected by swinging of the swing arm 23.

A rear brake hose 115 serving as second brake piping extending from a master cylinder 114 located on the right side in the vehicle width direction of the swing arm 23 is also routed on the inner side of the lower rear frame 29 on the right side in the vehicle width direction. The master cylinder 114 supported by the step plate 21 fixed on the pivot plate 19 side is not, in the first place, affected by swinging of the swing arm 23, but the rear brake hose 115 is similar to the brake piping 111 in that, by orienting a connection terminal (not shown) for the rear brake hose 115 formed by the ABS modulator 27 in the direction of extension of the lower rear frame 29, the rear brake hose 115 is routed along the lower rear frame 29 without using any restraining member.

Lower end portions of the left and right pivot plates 19 are mutually coupled by a frame block 119 supporting a mount volt 19a for the power unit P. The side stand 22 whose protruding position and retracted position are defined by the biasing force of a spring 22b is rotatably supported by a rotary shaft 22a.

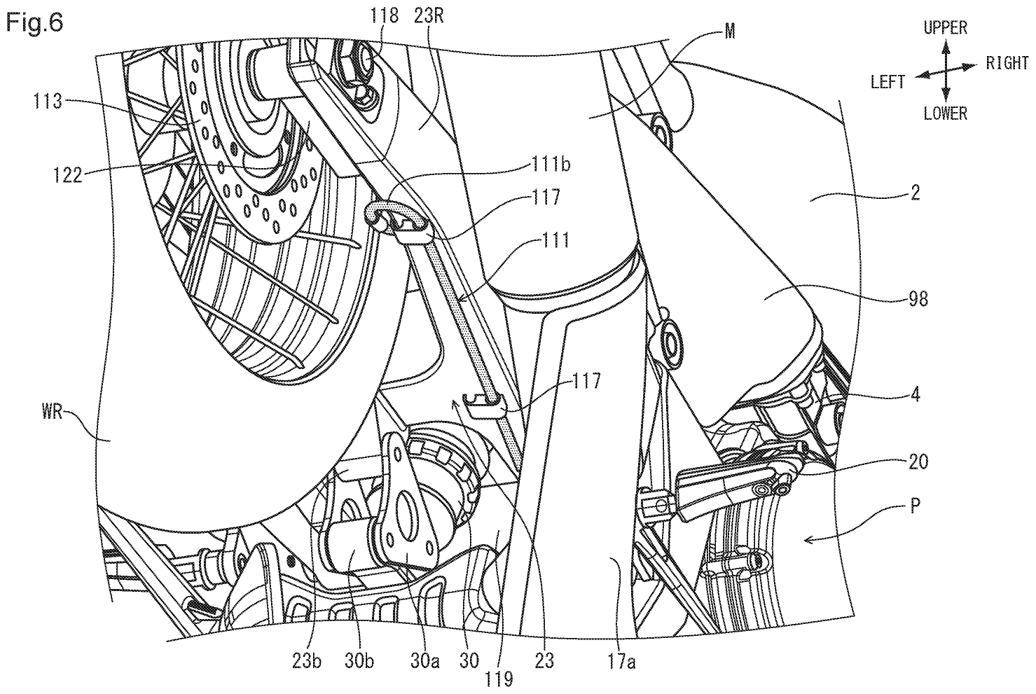

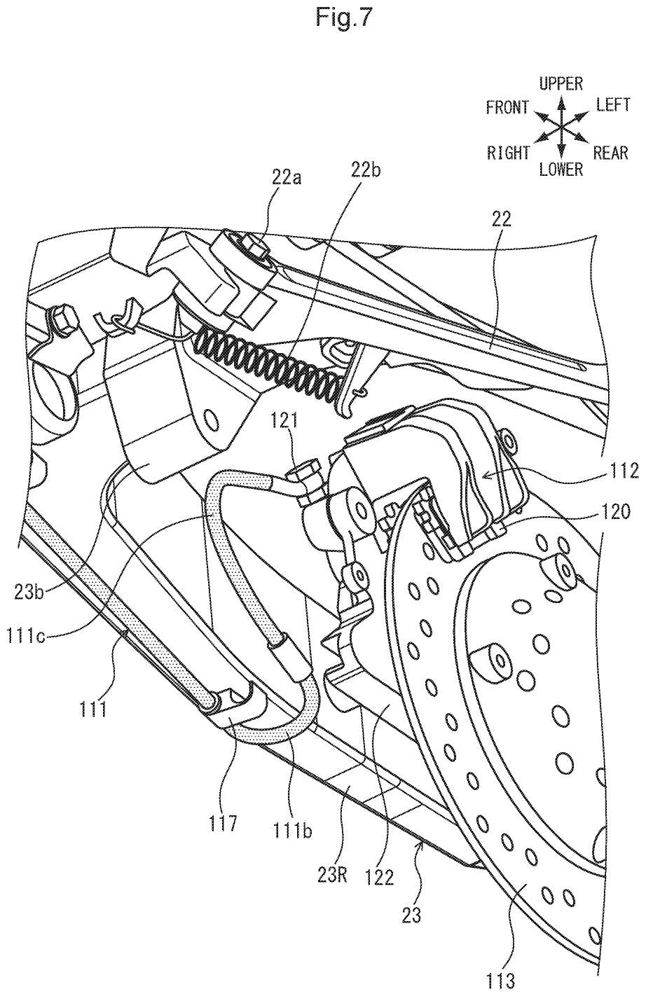

FIG. 6 is a perspective view of the swing arm 23 as seen from below. FIG. 7 is a perspective view of the configuration around the rear brake caliper 112 of the brake piping 111. The rear brake caliper 112 that presses brake pads 120 against both sides of the brake disc 113 is fixed to a mount plate 122 supported rotatably with respect to the rear wheel axle 118 and held unrotatably with respect to the swing arm 23.

The rear cushion 30 is disposed vertically extending through the swing arm 23 behind the cylindrical portion 23a of the swing arm 23. A lower end portion of the rear cushion 30 is pivotally supported at front end portions of link plates 30a. Lower end portions of the link plates 30a are pivotally supported by a link support portion 30b formed by the frame block 119. Upper end portions of the link plates 30a are supported by a link support portion 23b formed on the underside of the swing arm 23.

The brake piping 111 curved, in front of the pivot 18, rearward of the vehicle body is guided rearward of the vehicle body by being routed along the underside of a right arm portion 23R of the swing arm 23. The brake piping 111 is fixed by a holding member 117 formed of resin or the like to the underside of the right arm portion 23R. A rear end portion of the brake piping 111 is, by being curved at a second curving portion 111b, guided upward and forward of the vehicle body and is then, by being curved at a third curving portion 111c, guided rearward and upward of the vehicle body to reach the rear brake caliper 112. The rear end portion of the brake piping 111 is fixed by a banjo volt 121 to the rear brake caliper 112.

The brake piping 111 may be entirely formed of a general rubber brake hose, or, to make positioning of the brake piping 111 easier, a portion, for example, leading from the ABS modulator 27 to in front of the pivot 18 may be formed of a metal pipe or metal mesh hose.

As described above, the brake piping structure according to the present invention includes a pair of left and right lower rear frames 29 connected to a rear portion of a vehicle body frame 3 of the motorcycle 1 and supporting the seat 31, the swing arm 23 swingably supported, via a pivot 18, by the vehicle body frame 3, and brake piping 111 which conveys hydraulic pressure generated by the ABS modulator 27 to the rear brake caliper 112 for the rear wheel WR. The brake piping 111 extends, from the ABS modulator 27 disposed between the pair of left and right rear frames 29, forward and downward of the vehicle body along the lower rear frame 29, is curved rearward of the vehicle body in front of the pivot 18, and is then connected to the rear brake caliper 112 by being routed under the swing arm 23. Therefore, the brake piping 111 extending from the ABS module 27 can be easily routed along the inner side of the lower rear frame 29. This makes it possible to hide the brake piping 111 by the lower rear frame 29 and improve appearance property. Furthermore, curving the brake piping 111 rearward in front of the pivot 18 makes it unnecessary to use plural restraining members for routing the brake piping 111 along the lower rear frame 29, so that the number of parts and production man-hours can be reduced. At the same time, since curving of the brake piping 111 can be made small, effects of swinging of the swing arm 23 can be suppressed, and the brake piping 111 can be prevented from interfering with other parts.

The motorcycle form, the shapes and structures of the vehicle body frames, the shapes and structures of the upper rear frames and lower rear frames, the shape and position of the ABS modulator, the shape and structure of the swing arm, the structure and position of the rear brake caliper, the material of the brake piping, etc. are not limited to the above embodiment and can be variously changed. The brake piping structure for the saddled vehicles according to the present invention can be applied not only to the motorcycles but also to such the saddled vehicles as tricycles and four-wheeled vehicles.

### REFERENCE SIGNS LIST

1 . . . motorcycle (saddled vehicle), 3 . . . vehicle body frame, 18 . . . pivot, 19 . . . pivot plate, 23 . . . swing arm, 23a . . . cylindrical portion, 27 . . . ABS modulator, 28 . . . upper rear frame, 29 . . . lower rear frame (rear frame), 31 . . . seat, 102 . . . brake pedal, 110 . . . connection terminal, 111 . . . brake piping, 112 . . . rear brake caliper, 114 . . . master cylinder, 115 . . . rear brake hose (second brake piping), 116 . . . guide member, WR . . . rear wheel

1. A brake piping structure for saddled vehicles, comprising:
a pair of left and right rear frames connected to a rear portion of a vehicle body frame of the saddled vehicle and supporting a seat;
a swing arm swingably supported, via a pivot, by the vehicle body frame; and
brake piping, which conveys hydraulic pressure generated by an ABS modulator to a rear brake caliper for a rear wheel,
wherein the ABS modulator is disposed between the pair of left and right rear frames, and
wherein the brake piping extends from the ABS modulator forward and downward of the vehicle body along the rear frame, and is, by being curved rearward of the vehicle body in front of the pivot and then by being routed under the swing arm, connected to the rear brake caliper.

2. The brake piping structure for the saddled vehicles according to claim 1,
wherein a connection terminal for the brake piping is provided at the ABS modulator, and the connection terminal is oriented forward and downward of the vehicle body along the rear frame.

3. The brake piping structure for the saddled vehicles according to claim 1,
wherein an arc-like guide member for guiding the brake piping is attached to a cylindrical portion pivotally supporting the pivot at a front end portion of the swing arm.

4. The brake piping structure for the saddled vehicles according to claim 3,
wherein at least a portion, leading from the ABS modulator to in front of the guide member, of the brake piping is formed of a metal hose.

5. The brake piping structure for the saddled vehicles according to claim 1,
wherein the brake piping structure includes a master cylinder, which generates hydraulic pressure responding to operation of a brake pedal,
wherein the master cylinder is fixed to a pivot plate pivotally supporting the pivot, and
wherein second brake piping, which conveys hydraulic pressure generated at the master cylinder to the ABS modulator, is routed on an inner side in the vehicle width direction of the rear frame.

6. The brake piping structure for the saddled vehicles according to claim 2,
wherein an arc-like guide member for guiding the brake piping is attached to a cylindrical portion pivotally supporting the pivot at a front end portion of the swing arm.

7. The brake piping structure for the saddled vehicles according to claim 2,
wherein the brake piping structure includes a master cylinder, which generates hydraulic pressure responding to operation of a brake pedal,
wherein the master cylinder is fixed to a pivot plate pivotally supporting the pivot, and
wherein second brake piping, which conveys hydraulic pressure generated at the master cylinder to the ABS modulator, is routed on an inner side in the vehicle width direction of the rear frame.

8. The brake piping structure for the saddled vehicles according to claim 3,
wherein the brake piping structure includes a master cylinder, which generates hydraulic pressure responding to operation of a brake pedal,
wherein the master cylinder is fixed to a pivot plate pivotally supporting the pivot, and
wherein second brake piping, which conveys hydraulic pressure generated at the master cylinder to the ABS modulator, is routed on an inner side in the vehicle width direction of the rear frame.

9. The brake piping structure for the saddled vehicles according to claim 4,
wherein the brake piping structure includes a master cylinder, which generates hydraulic pressure responding to operation of a brake pedal,
wherein the master cylinder is fixed to a pivot plate pivotally supporting the pivot, and
wherein second brake piping, which conveys hydraulic pressure generated at the master cylinder to the ABS modulator, is routed on an inner side in the vehicle width direction of the rear frame.
